(19) United States
(12) Patent Application Publication
(10) Pub. No.: US 2026/0097753 A1
(43) Pub. Date: Apr. 9, 2026

(54) HYBRID ELECTRIC VEHICLE MANAGEMENT FOR WATERLOGGED ROAD

(71) Applicant: INTERNATIONAL BUSINESS MACHINES CORPORATION, Armonk, NY (US)

(72) Inventors: Yu Zhu, Beijing (CN); Jun Su, Beijing (CN); Su Liu, Austin, TX (US); Peng Hui Jiang, Beijing (CN); Guang Han Sui, Beijing (CN); Jun Feng Duan, Beijing (CN)

(21) Appl. No.: 18/905,258

(22) Filed: Oct. 3, 2024

(51) Int. Cl. B60W 20/15

(52) U.S. Cl. CPC B60W 20/15; B60W 2520/00; B60W 2555/20

(57) ABSTRACT

A computer-implemented method may include receiving, by a processor set, environmental data, vehicle data, and traffic data; identifying, by the processor set, a road segment based on the environmental data; identifying, by the processor set, a risk associated with the road segment based on the environmental data, vehicle data, and traffic data; determining, by the processor set, a driving mode based on the risk, wherein the driving mode comprises a battery priority mode and a fuel priority mode; and instructing, by the processor set, a hybrid electric vehicle (HEV) to enforce the driving mode, wherein the instructing causes the HEV to change the driving mode.

### BACKGROUND

Aspects of the present invention relate generally to vehicle management systems including automatically managing propulsion systems of electric vehicles and hybrid electric vehicles (collectively, HEV).

Advanced driver assistance systems (ADAS) in HEVs provide improved driver safety functionality in vehicle management systems. In some cases, vehicle-to-vehicle (V2V) and vehicle-to-everything (V2X) data may improve vehicle management systems by incorporating environmental considerations into safety functionality considerations.

### SUMMARY

In a first aspect of the invention, there is a computer-implemented method including: receiving, by a processor set, environmental data, vehicle data, and traffic data; identifying, by the processor set, a road segment based on the environmental data; identifying, by the processor set, a risk associated with the road segment based on the environmental data, vehicle data, and traffic data; determining, by the processor set, a driving mode based on the risk, wherein the driving mode comprises a battery priority mode and a fuel priority mode; and instructing, by the processor set, a hybrid electric vehicle (HEV) to enforce the driving mode, wherein the instructing causes the HEV to change the driving mode.

In another aspect of the invention, there is a computer program product including one or more computer readable storage media having program instructions collectively stored on the one or more computer readable storage media. The program instructions are executable to: receive environmental data, vehicle data, and traffic data; identify a road segment based on the environmental data; identify a risk associated with the road segment based on the environmental data, vehicle data, and traffic data; determine a driving mode based on the risk, wherein the driving mode comprises a battery priority mode and a fuel priority mode; and instruct a hybrid electric vehicle (HEV) to enforce the driving mode, wherein the instructing causes the HEV to change the driving mode.

In another aspect of the invention, there is a system including a processor set, one or more computer readable storage media, and program instructions collectively stored on the one or more computer readable storage media. The program instructions are executable to: receive environmental data, vehicle data, and traffic data; identify a road segment based on the environmental data; identify a risk associated with the road segment based on the environmental data, vehicle data, and traffic data; determine a driving mode based on the risk, wherein the driving mode comprises a battery priority mode and a fuel priority mode; and instruct a hybrid electric vehicle (HEV) to enforce the driving mode, wherein the instructing causes the HEV to change the driving mode.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an exemplary method in accordance with aspects of the present invention.

FIG. 4 shows a block diagram of an exemplary method in accordance with aspects of the present invention.

FIG. 5 shows a block diagram of an exemplary method in accordance with aspects of the present invention.

FIG. 6 shows a flowchart of an exemplary method in accordance with aspects of the present invention.

FIG. 7 shows a flowchart of an exemplary method in accordance with aspects of the present invention.

### DETAILED DESCRIPTION

Aspects of the present invention relate generally to vehicle management systems and, more particularly, to systems for collecting vehicle, traffic, and environmental data, performing risk analysis associated with the vehicle, traffic, and environmental data to identify risk to vehicle safety, and adjusting vehicle drive systems to compensate for the identified risk. According to aspects of the present invention, a vehicle management system may be configured to: collect real-time data via a V2X network, the data including vehicle data, traffic data, and user data; and determine one or more waterlogged road segments on a route. According to aspects of the present invention, a vehicle management system may include a risk analysis module that evaluates the potential risk for vehicle driving based on collected information.

According to aspects of the present invention, a vehicle management system may include a routing decision making module configured to generate segment-by-segment driving strategy based on the risk analysis module, before reaching the waterlogged road, which includes driving mode selection. The risk analysis module may evaluate the potential risk for vehicle driving based real-time waterlogged road information, estimated drive-through scenario, and safety requirements for each driving mode. The routing decision making module may provide vehicle management decisions based on risk analysis including modifying a driving mode, speed, or direction. According to aspects of the present invention, a vehicle management system may include a vehicle management enforcement module to apply the decision to vehicle system.

In embodiments, the computer program product, method, or system of waterlogged road driving management in an HEV, may include the following steps: collecting real-time data (e.g., vehicle speed, fuel consumption rate, battery consumption rate, fuel tank capacity, battery capacity, battery charging rate, driver behavior data, special requirement in driving such as noisy level, road condition, traffic status, regulation area, weather information, etc.) from on-vehicle sensors and V2V and V2X networks; determining one or more waterlogged road segment ahead via the V2X network; and analyzing the data to identify the potential risk of the waterlogged road based on the collected data, current route plan, and status of waterlogged road. The potential risk includes the safety risks related to both battery mode and internal combustion engine mode, including whether internal combustion engine mode is safe on the waterlogged road segment and whether battery mode is safe on the waterlogged road segment, or a fuel/battery risk exists for driving through waterlogged road segment. Based on the risk analysis result, the system may revise routing before approaching the waterlogged road segment, including making a segment route to the vehicle navigation system, determining a driving mode for each segment, and determining a fuel/refill and battery charging plan for the route. The computer program product, method, or system may analyze the data to identify the potential risk of the waterlogged road based on the collected data, current route plan, and status of the waterlogged road when the vehicle drives through the waterlogged road segment. Based on the risk analysis results, the system may make decisions on driving mode to drive through the waterlogged road segment, which includes a driving mode switch based on safety requirements, real-time road status, and vehicle data, and enforcing the decisions to the vehicle driving systems. In some embodiments, the computer program product, method, or system may provide visual/audio notifications about actions and risks to a driver or provide multiple suggestions in route planning.

HEVs optimize energy usage to achieve enhanced efficiency to extend the vehicle's range and ensure a longer driving experience between charging or refueling sessions, providing convenience to users. HEVs may minimize carbon dioxide emissions, contributing significantly to environmental sustainability. By reducing the carbon footprint associated with traditional combustion engine vehicles, HEVs actively support global efforts to mitigate climate change and prevent further environmental degradation. Incorporating intelligent systems in HEVs contributes to an overall improved user experience. Advanced technologies, such as regenerative braking and intelligent power management, work seamlessly to provide a smooth and responsive driving experience. Users benefit from the harmonious integration of electric and internal combustion power, offering a blend of performance and efficiency. HEVs not only prioritize environmental benefits but also result in potential financial savings for users. The fuel efficiency achieved through smart energy management means reduced fuel consumption, translating into cost savings over time. This dual advantage of economic and environmental benefits makes HEVs an attractive and sustainable choice for conscientious drivers.

HEVs may require compliance with electrical enclosure ratings indicating certain protections from water or contaminants. In particular, HEVs, including both electric and combustion-based propulsion systems, require additional safety measures to remain water and contaminant-resistant. In conventional systems, user-controlled switching from electric-based propulsion systems (“battery priority”) to combustion-based propulsion systems (“fuel priority”) in a waterlogged road setting may result in damage to a vehicle. Also in conventional systems, automatic switching from battery priority to fuel priority may occur without user input when battery capacity reaches a threshold. Automatic switching may occur in a waterlogged road, resulting in damage to a vehicle at no fault to the user.

As a non-limiting use case example, when HEVs traverse waterlogged roads, e.g., roads having moving or standing water on them, including puddles, rainwater, or flooding, the strategic activation of the internal combustion engine in the middle of the water poses a potential risk to engine integrity. Addressing this challenge requires innovative solutions to minimize the likelihood of damage while ensuring optimal vehicle performance. The disclosed computer program product, method, or system may automatically switch to internal combustion mode in intelligent driving scenarios to reduce damage risk and improve safety. System calibration may prevent untimely activations that could compromise the vehicle's safety and longevity. Ensuring effective sealing and protective measures may protect the vehicle against potential water-related risks and integrating real-time water level sensors into the HEV's management system provides useful data for decision-making. This allows the vehicle to assess the water depth on the road and make informed choices on engine activation, contributing to overall safety. Leveraging vehicle-to-environment connectivity within a V2X network, collaborative solutions can be implemented to enhance the overall safety of HEVs on waterlogged roads. Real-time communication between vehicles and the environment allows collective adaptation to challenging road conditions.

In embodiments, the computer program product, method, or system may include the steps of receiving environmental data, vehicle data, and traffic data. Environmental data may include climate and weather information relating to a road or route a vehicle is traveling on, such as the presence of water on the road. Vehicle data may include speed, fuel consumption rate, battery consumption rate, fuel consumption and tank capacity, battery capacity, battery charging rate, etc. Traffic data may include road conditions, traffic status, speed limits, etc. In embodiments, the system may receive user data including driving behavioral data and point-of-interest (POI) data including vehicle charging and fueling locations. In embodiments, the computer program product, method, or system may include identifying a road segment based on the environmental data, e.g., analyzing environmental data to identify waterlogged roads by correlating weather patterns and data to route planning data. In embodiments, the computer program product, method, or system may include identifying a risk associated with the road segment based on the environmental data, vehicle data, and traffic data, e.g., correlating fuel and battery consumption over time to the analyzed environmental data and route planning data to determine that the vehicle is at risk of damage if it does not adjust its driving mode (battery priority or fuel priority). As used herein, “correlating” may refer to cross-referencing or compiling environmental data, vehicle data, and traffic data in a table, graph, etc., to identify a vector (magnitude and direction) representing the relationship between two or more variables or data points. In embodiments, the computer program product, method, or system may include determining a driving mode based on the risk, e.g., determining that a waterlogged road is on the route of a traveling vehicle, and adjusting the driving mode to avoid damage to the vehicle based on the determining. In embodiments, the computer program product, method, or system may include instructing an HEV to enforce the driving mode, e.g., communicating computer-executable instructions to an HEV client that instructs the HEV to adjust the driving mode.

Implementations of the present invention involve the technical field of vehicle management systems including automatically managing propulsion systems, and are therefore necessarily rooted in computer technology. For example, the steps of identifying, by the processor set, a road segment based on the environmental data, identifying, by the processor set, a risk associated with the road segment based on the environmental data, vehicle data, and traffic data, determining, by the processor set, a driving mode based on the risk, and instructing, by the processor set, an HEV to enforce the driving mode are computer-based and cannot be performed in the human mind. For example, measuring or calculating environmental data and communicating it to a server or vehicle, calculating risk associated with a road based on multiple variables associated with environmental data, vehicle data, and traffic data, determining a safest, low risk driving mode based on the calculated risk, and communicating instructions to an HEV to automatically change driving mode based on the risk amounts to more than merely implementing a generic computer as a tool to gather, analyze, and output data. Similarly, implementations of the present invention would be impossible to accomplish on pen and paper due to the volume of data being measured and calculated in real-time as a vehicle travels. In particular, the speed at which the measuring and communication of data, including environmental data, vehicle data, and traffic data determined, in some cases, via global positions systems, occurs in order to effectuate the disclosed method, system, or computer program product would involve large-scale, continuous monitoring, calculation, and wireless communication of such data. These features would be impossible to accomplish on pen and paper and cannot be accomplished as a method of organizing human activity.

In embodiments, a computer-implemented method may include receiving environmental data, vehicle data, and traffic data, identifying a road segment based on the environmental data, identifying a risk associated with the road segment based on the environmental data, vehicle data, and traffic data, determining a driving mode based on the risk, wherein the driving mode includes a battery priority mode and a fuel priority mode, and instructing a hybrid electric vehicle (HEV) to enforce the driving mode, wherein the instructing causes the HEV to change the driving mode. Aspects of the present invention improve driver safety functionality in an HEV by automatically changing driving modes based on an identified risk, thereby reducing the risk associated with traffic and roadway conditions.

In embodiments, a computer-implemented method may include environmental data, including road segment surface water data, vehicle data, including vehicle speed, and traffic data, including near-vehicle proximity data. Aspects of the present invention improve driver safety functionality in an HEV by automatically changing driving modes based on surface water, speed, and near-vehicle proximity, thereby reducing risk associated with specific driving conditions.

In embodiments, a computer-implemented method may include identifying the risk associated with the road segment based on the environmental data, vehicle data, and traffic data, including comparing the road segment surface water data to the vehicle speed and the near-vehicle proximity data to identify a damage risk associated with damage to the HEV. Aspects of the present invention improve driver safety functionality in an HEV by automatically identifying risks associated with potential damage to an HEV and adjusting a driving mode to reduce the risk.

In embodiments, a computer-implemented method may include receiving the environmental data, including receiving an approximation of surface water present on the road segment. Aspects of the present invention improve driver safety functionality in an HEV by automatically changing driving modes based on surface water present on a roadway to reduce risk of vehicle accident, damage, or failure with respect to the surface water.

In embodiments, a computer-implemented method may include identifying the road segment based on the environmental data includes identifying a plurality of road segments, and categorizing the plurality of road segments based on the approximation of surface water present on the road segment. Aspects of the present invention improve driver safety functionality in an HEV by categorizing road segments based on surface water present and adjusting driving mode accordingly to reduce risk.

In embodiments, a computer-implemented method may include identifying the risk associated with the road segment including identifying a risk associated with a category of each of the plurality of road segments. Aspects of the present invention improve driver safety functionality in an HEV by categorizing road segments and identifying corresponding road segment risks in order to facilitate safe driving.

In embodiments, a computer-implemented method may include determining the driving mode based on the risk, including determining a plurality of driving modes based on the risk associated with the category of each of the plurality of road segments. Aspects of the present invention improve driver safety functionality in an HEV by adjusting a driving mode to address and identified risk, thereby reducing risk and increasing safety.

In embodiments, a computer-implemented method may include a plurality of driving modes including a first driving mode, a second driving mode, and a third driving mode, and wherein the instructing the HEV to enforce the plurality of driving modes includes instructing the HEV to enforce the first driving mode at a first road segment based on a first set of environmental data, vehicle data, and traffic data, instructing the HEV to enforce the second driving mode at a second road segment based on a second set of environmental data, vehicle data, and traffic data, and instructing the HEV to enforce the third driving mode at a third road segment based on a third set of environmental data, vehicle data, and traffic data. Aspects of the present invention improve driver safety functionality in an HEV by categorizing numerous road segments and adjusting a driving mode to reduce the risk associated with each individual road segment. In embodiments, a computer program product may include one or more computer readable storage media having program instructions collectively stored on the one or more computer readable storage media, the program instructions executable to receive environmental data, vehicle data, and traffic data, identify a road segment based on the environmental data, identify a risk associated with the road segment based on the environmental data, vehicle data, and traffic data, determine a driving mode based on the risk, wherein the driving mode includes a battery priority mode and a fuel priority mode, and instruct a hybrid electric vehicle (HEV) to enforce the driving mode, wherein the instructing causes the HEV to change the driving mode.

Aspects of the present invention improve driver safety functionality in an HEV by automatically changing driving modes based on an identified risk, thereby reducing the risk associated with traffic and roadway conditions.

In embodiments, a computer program product may include environmental data, including road segment surface water data, vehicle data, including vehicle speed, and traffic data, including near-vehicle proximity data. Aspects of the present invention improve driver safety functionality in an HEV by automatically changing driving modes based on surface water, speed, and near-vehicle proximity, thereby reducing risk associated with specific driving conditions.

In embodiments, a computer program product may include identifying the risk associated with the road segment based on the environmental data, vehicle data, and traffic data, including comparing the road segment surface water data to the vehicle speed and the near-vehicle proximity data to identify a damage risk associated with damage to the HEV. Aspects of the present invention improve driver safety functionality in an HEV by automatically identifying risks associated with potential damage to an HEV and adjusting a driving mode to reduce the risk.

In embodiments, a computer program product may include receiving the environmental data, including receiving an approximation of surface water present on the road segment. Aspects of the present invention improve driver safety functionality in an HEV by automatically changing driving modes based on surface water present on a roadway to reduce risk of vehicle accident, damage, or failure with respect to the surface water.

In embodiments, a computer program product may include identifying the road segment based on the environmental data, including identifying a plurality of road segments, and categorizing the plurality of road segments based on the approximation of surface water present on the road segment. Aspects of the present invention improve driver safety functionality in an HEV by categorizing road segments based on surface water present and adjusting driving mode accordingly to reduce risk.

In embodiments, a computer program product may include identifying the risk associated with the road segment includes identifying a risk associated with a category of each of the plurality of road segments. Aspects of the present invention improve driver safety functionality in an HEV by categorizing road segments and identifying corresponding road segment risks in order to facilitate safe driving.

In embodiments, a computer program product may include determining the driving mode based on the risk includes determining a plurality of driving modes based on the risk associated with the category of each of the plurality of road segments. Aspects of the present invention improve driver safety functionality in an HEV by adjusting a driving mode to address and identified risk, thereby reducing risk and increasing safety.

In embodiments, a computer program product may include a plurality of driving modes including a first driving mode, a second driving mode, and a third driving mode, and wherein the instructing the HEV to enforce the plurality of driving modes includes instructing the HEV to enforce the first driving mode at a first road segment based on a first set of environmental data, vehicle data, and traffic data, instructing the HEV to enforce the second driving mode at a second road segment based on a second set of environmental data, vehicle data, and traffic data, and instructing the HEV to enforce the third driving mode at a third road segment based on a third set of environmental data, vehicle data, and traffic data. Aspects of the present invention improve driver safety functionality in an HEV by categorizing numerous road segments and adjusting a driving mode to reduce the risk associated with each individual road segment.

In embodiments, a system may include one or more computer readable storage media having program instructions collectively stored on the one or more computer readable storage media, the program instructions executable to receive environmental data, vehicle data, and traffic data, identify a road segment based on the environmental data, identify a risk associated with the road segment based on the environmental data, vehicle data, and traffic data, determine a driving mode based on the risk, wherein the driving mode includes a battery priority mode and a fuel priority mode, and instruct a hybrid electric vehicle (HEV) to enforce the driving mode, wherein the instructing causes the HEV to change the driving mode. Aspects of the present invention improve driver safety functionality in an HEV by automatically changing driving modes based on an identified risk, thereby reducing the risk associated with traffic and roadway conditions.

In embodiments, a system may include environmental data, including road segment surface water data, vehicle data, including vehicle speed, and traffic data, including near-vehicle proximity data. Aspects of the present invention improve driver safety functionality in an HEV by automatically changing driving modes based on surface water, speed, and near-vehicle proximity, thereby reducing risk associated with specific driving conditions.

In embodiments, a system may include identifying the risk associated with the road segment based on the environmental data, vehicle data, and traffic data, including comparing the road segment surface water data to the vehicle speed and the near-vehicle proximity data to identify a damage risk associated with damage to the HEV. Aspects of the present invention improve driver safety functionality in an HEV by automatically identifying risks associated with potential damage to an HEV and adjusting a driving mode to reduce the risk.

In embodiments, a system may include receiving the environmental data, including receiving an approximation of surface water present on the road segment. Aspects of the present invention improve driver safety functionality in an HEV by automatically changing driving modes based on surface water present on a roadway to reduce risk of vehicle accident, damage, or failure with respect to the surface water.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as HEV management code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

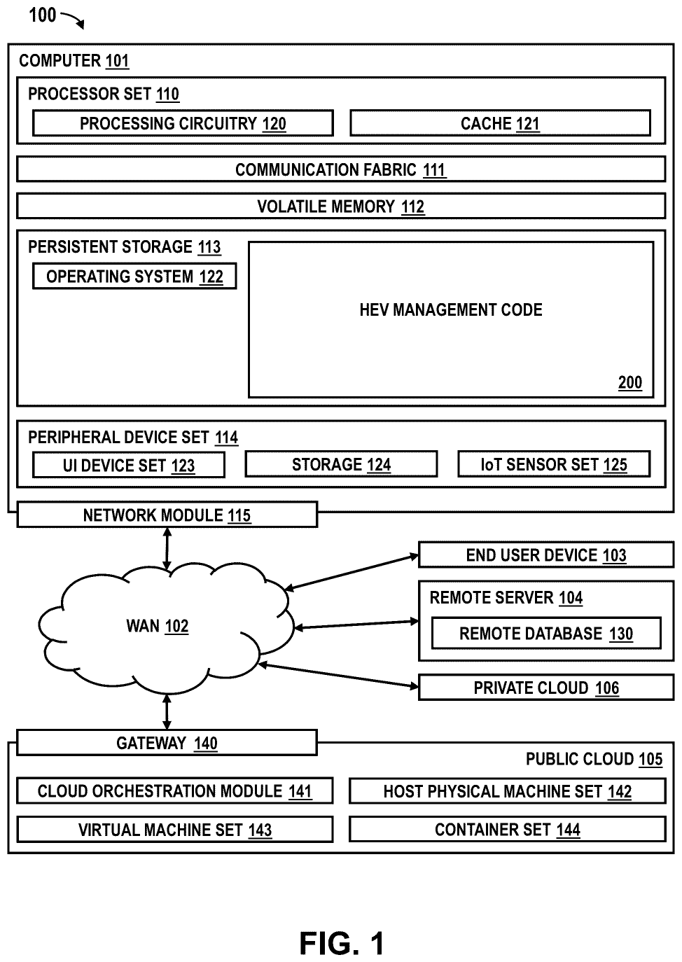

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

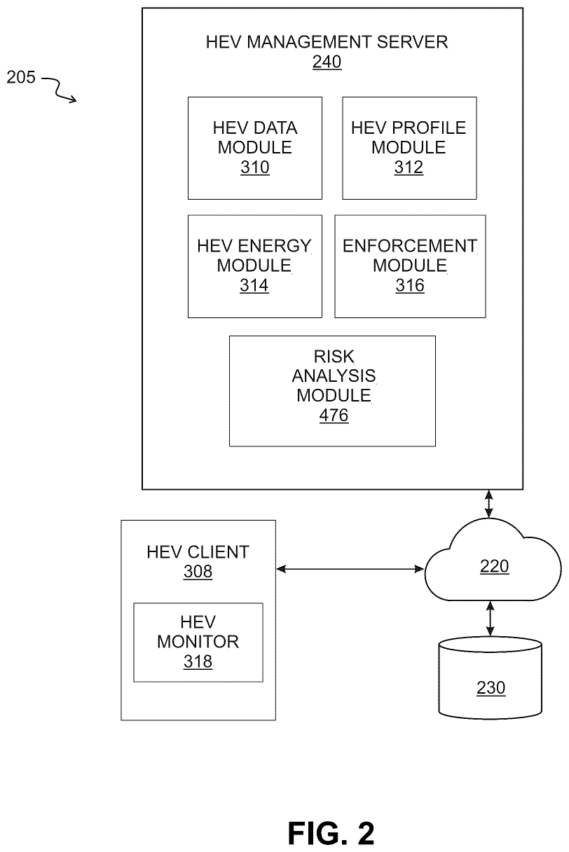

FIG. 2 shows a block diagram of an exemplary environment 205 in accordance with aspects of the present invention. In embodiments, the environment 205 includes an HEV management server 240 corresponding to computer 101 of FIG. 1. The HEV management server 240 may include modules corresponding to block 200 of FIG. 1 including an HEV data module 310, an HEV profile module 312, an HEV energy module 314, an enforcement module 316, and a risk analysis module 476. The HEV management server 240 may be operable communication with an HEV client 308 over WAN 220 corresponding to WAN 102 of FIG. 1. The HEV client 308 may be a remote program or application configured to interact with the HEV management server 240 to request or receive information, such as vehicle, traffic, and environmental data, as well as perform specific tasks on behalf of the HEV management server 240, such as enforcing HEV management server 240 instructions to adjust an HEV driving mode. In embodiments, the HEV client 308 corresponds to EUD 103 of FIG. 1 and is in operable communication with database 230 corresponding to remote server 104 or remote database 130 of FIG. 1.

In embodiments, the HEV management server 240 of FIG. 2 comprises HEV data module 310, HEV profile module 312, HEV energy module 314, enforcement module 316, and risk analysis module 476, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods described herein. The HEV management server 240 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

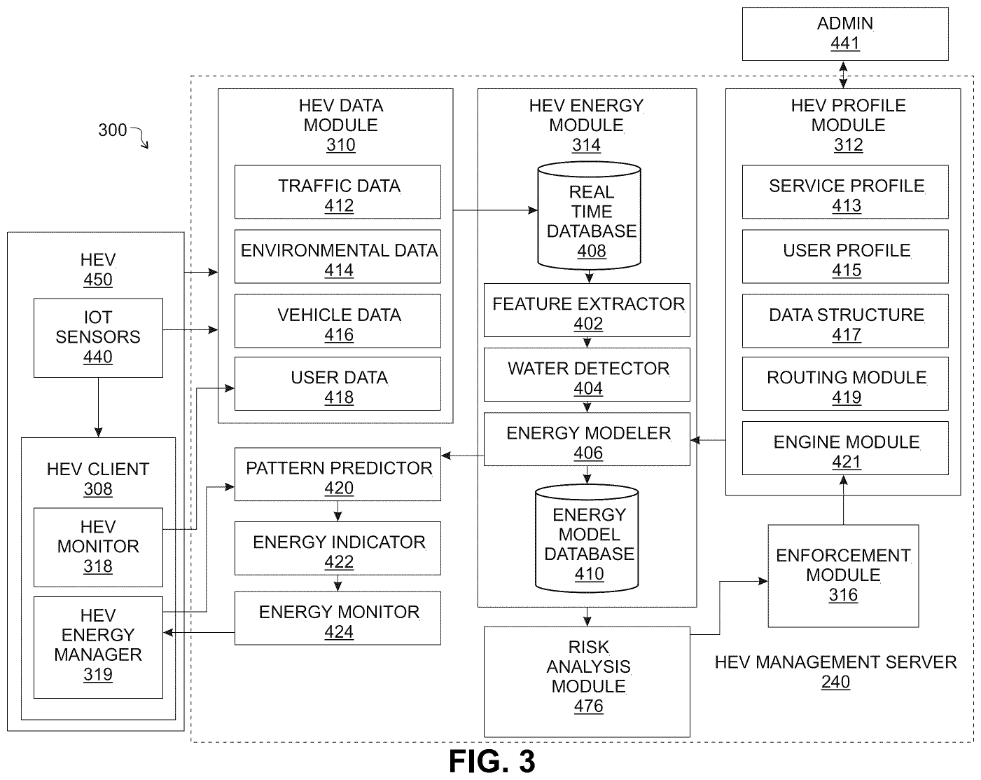

FIG. 3 shows a block diagram 300 of an exemplary environment in accordance with aspects of the present invention. Steps of the method may be carried out in the environment of FIG. 2 and are described with reference to elements depicted in FIG. 2.

An HEV 450 may include onboard IOT sensors 440 in operable communication with an HEV client 308 corresponding to the HEV client 308 of FIG. 2. The HEV client 308 may include an HEV monitor 318 and an HEV energy manager 319. The HEV monitor 318 may monitor and capture real-time data from the IOT sensors 440 and communicate it to the HEV data module 310 and pattern predictor 420. The HEV energy manager 319 may monitor and capture HEV fuel levels, battery charge, fuel, and charge depletion, etc., to estimate the remaining travel range, i.e., how far the vehicle may travel on its remaining fuel and charge. In embodiments, the pattern predictor 420 may be a software module configured to receive, through the HEV client 308, user input to adjust vehicle settings for travel time, routing, and energy usage. An energy indicator 422 may be a software module configured to collect, through the HEV client 308, user feedback after travel relating to the accuracy of the estimated remaining travel range calculated by the HEV energy manager 319. An energy monitor 424 may be a software module configured to determine discrepancies between the user feedback and the accuracy of the estimated remaining travel range, which may be communicated to the HEV energy manager 319, and, in response, the HEV energy manager 319 may adjust estimations on remaining travel range for an HEV 450.

The HEV data module 310 is configured to receive traffic data 412, environmental data 414, vehicle data 416, and user data 418 from an HEV 450 having an HEV client 308. In embodiments, this is done by measuring the traffic data 412, environmental data 414, vehicle data 416, and user data 418 via the IOT sensors 440 onboard HEV 450. In other embodiments, this is done by receiving traffic data 412, environmental data 414, vehicle data 416, and user data 418 from the HEV management server 240, which may aggregate traffic data 412, environmental data 414, vehicle data 416, and user data 418 from a variety of remote or local sources, such as real-time database 408 corresponding to database 230 of FIG. 2. In embodiments, the real-time database 408 may store environmental data, including road segment surface water data measured via IOT sensors 440 or received from a remote server or database, vehicle data, including vehicle speed measured by the HEV 450, and traffic data including near-vehicle proximity data, measured or collected via global positioning systems. In embodiments, the environmental data 414 may include an approximation of surface water present on the road segment determined from an external source, or determined via feature extraction of the environmental data 414 performed by the HEV energy module 314.

The HEV energy module 314 is configured to identify a road segment based on environmental data, vehicle data, or traffic data. In embodiments, this is done by performing feature extraction on data within the real-time database 408 via the feature extractor 402, which may be a software module. Feature extraction is done by, for example, text vectorization, correlation, pattern recognition, or other automated feature extraction. A road segment may be identified by correlating the road on which the HEV travels to environmental data, vehicle data, or traffic data in the real-time database 408. In embodiments, the HEV energy module 314 may identify a plurality of road segments and categorize the plurality of road segments based on the approximation of surface water present on the road segment. For example, road segments may be based on the volume, depth, or length of water on a road. A water detector 404 may be a software module configured to receive extracted features from the feature extractor 402, indicating water on the road on which the HEV travels. For example, environmental data 414 may include rainfall data, and vehicle data 416 may include vehicle speed and the road on which a vehicle travels. Environmental data 414 and vehicle data 416 may be correlated to indicate that the road on which a vehicle travels may have standing water due to recent rainfall. The HEV energy module 314 may include energy modeler 406, which may be a software module configured to train an algorithm using data associated with a service profile 413, user profile 415, data structure 417, routing module 419, and engine module 421. The energy modeler 406 may be configured to predict optimal energy usage for route segments based on input parameters, such as inputs from the real-time database 408 or the HEV profile module 312, which may be stored in the energy model database 410.

The risk analysis module 476 is configured to identify a risk associated with the road segment based on environmental data, vehicle data, and traffic data. In embodiments, the risk analysis module 476 is configured to identify risks associated with a category of each road segment in a plurality of road segments. In embodiments, this is done by associating known risks to the correlation performed by the HEV energy module 314. Risk may be determined based on pre-existing rules, such as a known risk associated with water on a roadway. In embodiments, the risk may be determined dynamically by comparing the correlation performed by the HEV energy module 314 to vehicle data to identify estimated driving requirements, including speed, estimated driving duration, and driving mode requirements. Similarly, longer routes through waterlogged areas may pose higher fuel or battery consumption risks, and the severity and duration of driving through waterlogged roads can impact fuel or battery efficiency. In embodiments, identifying the risk associated with the road segment may be based on the environmental data, vehicle data, and traffic data, including comparing the road segment surface water data to the vehicle speed and the near-vehicle proximity data (identified via GPS) to identify a risk associated with damage to the HEV. For example, the risk analysis module 476 may identify a risk based on the presence of road segment surface water data and vehicle speed, such as determining that an HEV will reach a waterlogged road segment in approximately five minutes of travel time, and, in response to approaching the waterlogged road segment, determine a driving mode based on the risk to prevent damage to the HEV as it travels through the waterlogged road segment. Determining a drive mode may be ruled-based, e.g., switching to battery priority or fuel priority driving mode may be dependent on volume, depth, or length of water present on a road.

The HEV profile module 312 is configured to allow administrators 441 and users to configure a service profile 413, user profile 415, data structure 417, routing module 419, and engine module 421. The service profile 413 may include user preferences or parameters relating to vehicle driving behavior such as speed, acceleration, braking, etc. The user profile 415 may include user preferences relating to preferred driving modes, such as battery priority or fuel priority. The data structure 417 may include a format for organizing, managing, and storing data relating to the service profile 413, the user profile 415, the routing module 419, and the engine module 421. The routing module 419 may include an algorithm configured to identify the plurality of road segments in conjunction with the HEV energy module 314 and categorize the plurality of road segments based on the approximation of surface water present on the road segment. In some embodiments, the routing module 419 may identify road segments unpassable due to water presence on the road, and provide alternate route planning to the HEV client 308. Similarly, the engine module 421 may include an algorithm configured to execute, in conjunction with the enforcement module 316, the ruled-based driving mode changes required by the risk analysis module 476. For example, the risk analysis module 476 may communicate a risk to the enforcement module 316, which, in response, may communicate instructions to enforce a specific driving mode to the HEV client 308 via the engine module 421. In response, the HEV client 308 may execute the instructions to enforce a specific driving mode.

The enforcement module 316 is configured to instruct an HEV to enforce a driving mode based on the identified driving mode best suited to address the identified risk of a road segment. In embodiments, the enforcement module 316 is configured to communicate a plurality of driving modes, including communicating instructions to enforce each driving mode in the plurality of driving modes as the HEV travels across each of the categories of each of the plurality of road segments. For example, the enforcement module 316 may instruct an HEV to switch from battery to fuel priority during a road segment having water present and switch back to battery while traveling on a dry road segment, or vice versa. In response to the instructions to switch from battery to fuel priority, or vice versa, the HEV may change from a first driving mode to a second driving mode. For example, the HEV may be instructed to enforce a first driving mode at a first road segment based on a first set of environmental data, vehicle data, and traffic data (e.g., instructions to use battery driving mode on a road segment with dry conditions and low traffic density). The HEV may also be instructed to enforce a second driving mode at a second road segment based on a second set of environmental data, vehicle data, and traffic data (e.g., instructions to use combustion engine driving mode on a road segment with snowy conditions, low battery charge capacity, and low traffic density). The HEV may also be instructed to enforce a third driving mode at a third road segment based on a third set of environmental data, vehicle data, and traffic data (e.g., instructions to use battery driving mode on a road segment with wet conditions regardless of traffic density). In this way, the HEV may receive instructions to change driving modes based on environmental data, vehicle data, and traffic data.

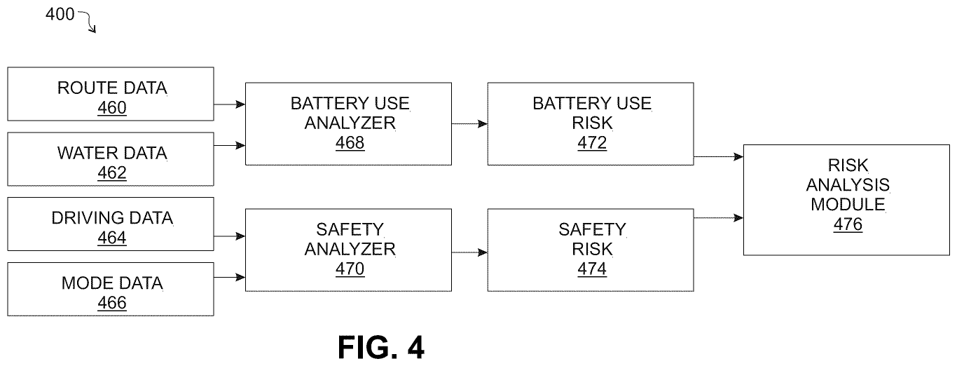

FIG. 4 shows a block diagram of an exemplary method 400 in accordance with aspects of the present invention. In embodiments, the risk analysis module 476, corresponding to the risk analysis module 476 of FIG. 3, is configured to identify risks associated with a category of each road segment in a plurality of road segments by analyzing route data 460, water data, 462, driving data 464, and mode data 466, which may correspond to traffic data 412, environmental data 414, vehicle data 416, and user data 418 of FIG. 3. In embodiments, route data 460 and water data 462 may be analyzed by a battery use analyzer 468, which may be a software module configured to identify a battery use risk 472. This may be done by correlating water data to route data to identify overlaps in the data indicating water is present on the road. Battery use risk 472 may include risks associated with long routes through waterlogged road segments that may increase battery charge consumption. Similarly, driving data 464 and mode data 466 may be analyzed by a safety analyzer 470, which may be a software module configured to identify a safety risk 474. This is done by comparing vehicle speed, drive duration, and driving mode to predefined driving safety risks, e.g., high vehicle speed and long drive duration poses a high risk of an accident. The risk analysis module 476 may consolidate battery use risk 472 and safety risk 474 and compare them to predefined risks or rules, such as a known risk associated with high vehicle speed traversing water on a roadway. In embodiments, the risk may be determined dynamically and in real-time.

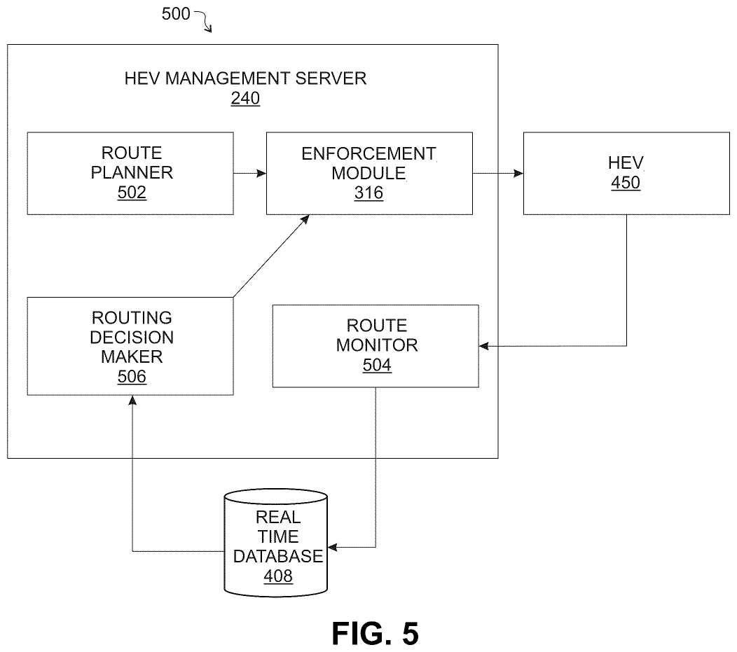

FIG. 5 shows a block diagram of an exemplary method 500 in accordance with aspects of the present invention. In embodiments, the HEV management server includes the enforcement module 316, corresponding to the enforcement module 316 of FIG. 3, which may be in operable communication with HEV 450 via the HEV client 308 of FIG. 3. A route planner 502 may be a software module configured to provide routing instructions to the enforcement module 316 and HEV 450. Routing instructions may include shortest or fastest route planning based on GPS data, digital map data, and traffic data, such as by using a searching algorithm configured to find the shortest path between an origin and a final location. A route monitor 504 may be a software module configured to monitor HEV position based on GPS data or other data in the real-time database 408 and continuously update routing plans as the current location of an HEV changes via the routing decision maker 506. In embodiments, the routing decision maker 506 updates routing plans based on the categorized road segments identified by the routing module 419, water detection, and drive modes required by the enforcement module 316 of FIG. 3.

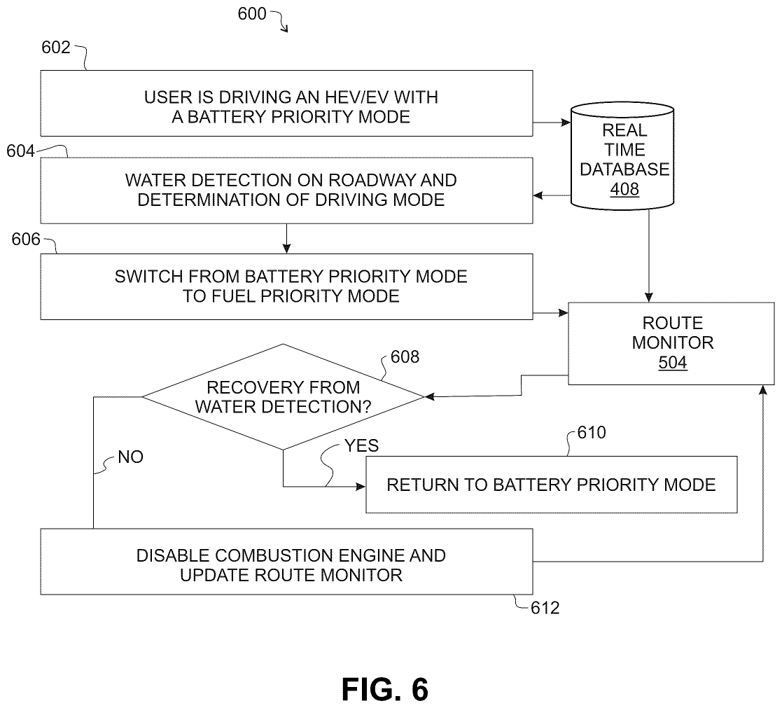

FIG. 6 shows a flowchart of an exemplary method 600 in accordance with aspects of the present invention. In step 602, a user may drive an HEV corresponding to HEV 450 of FIG. 5 in battery priority mode. The HEV management server 240 of FIG. 2 may identify a road segment by correlating the road on which the HEV travels to environmental data, vehicle data, or traffic data in the real-time database 408. In step 604, the HEV management server may perform water detection on the roadway and determine For example, the HEV management server 240 may identify a plurality of road segments and categorize the plurality of road segments based on the approximation of surface water present on the road segment via the HEV energy module 314 of FIG. 2. A water detector, such as the water detector 404 of FIG. 2, may receive extracted features from the feature extractor 402 of FIG. 3 indicating water on the road on which the HEV is traveling. In step 604, the HEV management server may also determine a driving mode based on water detection and road segment identification and categorization. In step 606, the HEV management server may switch from battery priority mode to fuel priority mode as dictated by the driving mode determination. A route monitor 504, corresponding to route monitor 504 of FIG. 5, may monitor HEV position based on GPS data or other data in the real-time database 408 and continuously update routing plans as the current location of an HEV changes. In embodiment, the HEV's current location will pass a road segment with water, indicating, in step 608, recovery from water detection. In response to detection recovery from water, the HEV management server may return to battery priority mode in step 610. In response to determining, in step 608, that recovery from water detection has not occurred, the HEV management server may disable the combustion engine and update the route monitor 504 in step 612. The updated route monitor 504 may update routing plans based on the categorized road segments identified by the routing module 419, water detection, and drive modes required by the enforcement module 316 of FIG. 3.

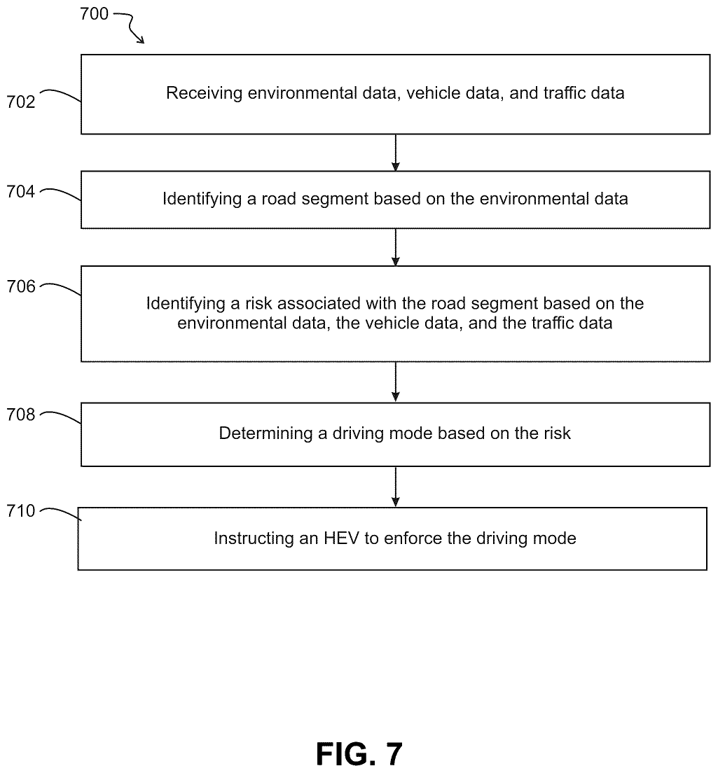

FIG. 7 shows a flowchart of an exemplary method 700 in accordance with aspects of the present invention. In step 702, the HEV management server 240 of FIG. 2 may receive environmental data, vehicle data, and traffic data via the HEV data module 310 of FIG. 3. In step 704, the HEV management server 240 may identify a road segment based on the environmental data via the HEV energy module 314 of FIG. 2. In step 706, the HEV management server 240 may identify a risk associated with the road segment based on the environmental data, the vehicle data, and the traffic data via the risk analysis module 476 of FIG. 2. In step 708, the HEV management server 240 may determine a driving mode based on the risk via the risk analysis module 476 of FIG. 2. In step 710, the HEV management server 240 may instruct an HEV to enforce the driving mode via the enforcement module 316 of FIG. 2.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, environmental data, vehicle data, and traffic data;
identifying, by the processor set, a road segment based on the environmental data;
identifying, by the processor set, a risk associated with the road segment based on the environmental data, vehicle data, and traffic data;
determining, by the processor set, a driving mode based on the risk, wherein the driving mode comprises a battery priority mode and a fuel priority mode; and
instructing, by the processor set, a hybrid electric vehicle (HEV) to enforce the driving mode, wherein the instructing causes the HEV to change the driving mode.

2. The computer-implemented method of claim 1, wherein the environmental data comprises road segment surface water data, the vehicle data comprises vehicle speed, and the traffic data comprises near-vehicle proximity data.

3. The computer-implemented method of claim 2, wherein the identifying the risk associated with the road segment based on the environmental data, vehicle data, and traffic data comprises comparing the road segment surface water data to the vehicle speed and the near-vehicle proximity data to identify a damage risk associated with damage to the HEV.

4. The computer-implemented method of claim 1, wherein the receiving the environmental data comprises receiving an approximation of surface water present on the road segment.

5. The computer-implemented method of claim 4, wherein the identifying the road segment based on the environmental data comprises:
identifying a plurality of road segments; and
categorizing the plurality of road segments based on the approximation of surface water present on the road segment.

6. The computer-implemented method of claim 5, wherein the identifying the risk associated with the road segment comprises identifying a risk associated with a category of each of the plurality of road segments.

7. The computer-implemented method of claim 6, wherein the determining the driving mode based on the risk comprises determining a plurality of driving modes based on the risk associated with the category of each of the plurality of road segments.

8. The computer-implemented method of claim 7, wherein the plurality of driving modes comprises a first driving mode, a second driving mode, and a third driving mode, and wherein the instructing the HEV to enforce the plurality of driving modes comprises:
instructing the HEV to enforce the first driving mode at a first road segment based on a first set of environmental data, vehicle data, and traffic data;
instructing the HEV to enforce the second driving mode at a second road segment based on a second set of environmental data, vehicle data, and traffic data; and
instructing the HEV to enforce the third driving mode at a third road segment based on a third set of environmental data, vehicle data, and traffic data.

9. A computer program product comprising one or more computer readable storage media having program instructions collectively stored on the one or more computer readable storage media, the program instructions executable to:
receive environmental data, vehicle data, and traffic data;
identify a road segment based on the environmental data;
identify a risk associated with the road segment based on the environmental data, vehicle data, and traffic data;
determine a driving mode based on the risk, wherein the driving mode comprises a battery priority mode and a fuel priority mode; and
instruct a hybrid electric vehicle (HEV) to enforce the driving mode, wherein the instructing causes the HEV to change the driving mode.

10. The computer program product of claim 9, wherein the environmental data comprises road segment surface water data, the vehicle data comprises vehicle speed, and the traffic data comprises near-vehicle proximity data.

11. The computer program product of claim 10, wherein the identifying the risk associated with the road segment based on the environmental data, vehicle data, and traffic data comprises comparing the road segment surface water data to the vehicle speed and the near-vehicle proximity data to identify a damage risk associated with damage to the HEV.

12. The computer program product of claim 9, wherein the receiving the environmental data comprises receiving an approximation of surface water present on the road segment.

13. The computer program product of claim 12, wherein the identifying the road segment based on the environmental data comprises:
identifying a plurality of road segments; and
categorizing the plurality of road segments based on the approximation of surface water present on the road segment.

14. The computer program product of claim 13, wherein the identifying the risk associated with the road segment comprises identifying a risk associated with a category of each of the plurality of road segments.

15. The computer program product of claim 14, wherein the determining the driving mode based on the risk comprises determining a plurality of driving modes based on the risk associated with the category of each of the plurality of road segments.

16. The computer program product of claim 15, wherein the plurality of driving modes comprises a first driving mode, a second driving mode, and a third driving mode, and wherein the instructing the HEV to enforce the plurality of driving modes comprises:
instructing the HEV to enforce the first driving mode at a first road segment based on a first set of environmental data, vehicle data, and traffic data;
instructing the HEV to enforce the second driving mode at a second road segment based on a second set of environmental data, vehicle data, and traffic data; and
instructing the HEV to enforce the third driving mode at a third road segment based on a third set of environmental data, vehicle data, and traffic data.

17. A system comprising:
a processor set, one or more computer readable storage media, and program instructions collectively stored on the one or more computer readable storage media, the program instructions executable to:
receive environmental data, vehicle data, and traffic data;
identify a road segment based on the environmental data;
identify a risk associated with the road segment based on the environmental data, vehicle data, and traffic data;
determine a driving mode based on the risk, wherein the driving mode comprises a battery priority mode and a fuel priority mode; and
instruct a hybrid electric vehicle (HEV) to enforce the driving mode, wherein the instructing causes the HEV to change the driving mode.

18. The system of claim 17, wherein the environmental data comprises road segment surface water data, the vehicle data comprises vehicle speed, and the traffic data comprises near-vehicle proximity data.

19. The system of claim 18, wherein the identifying the risk associated with the road segment based on the environmental data, vehicle data, and traffic data comprises comparing the road segment surface water data to the vehicle speed and the near-vehicle proximity data to identify a damage risk associated with damage to the HEV.

20. The system of claim 19, wherein the receiving the environmental data comprises receiving an approximation of surface water present on the road segment.
